(19) United States
(12) Patent Application Publication
(10) Pub. No.: US 2009/0222299 A1
(43) Pub. Date: Sep. 3, 2009

(54) SYSTEMS AND METHODS FOR DEFINING AND MANAGING TASK ORIENTED PROJECTS

(76) Inventors: Gregory Clemenson, Palo Alto, CA (US); Jeremy Clemenson, San Francisco, CA (US)

Correspondence Address: JONES DAY, 222 EAST 41ST ST, NEW YORK, NY, 10017, US

(21) Appl. No.: 12/040,840

(22) Filed: Feb. 29, 2008

(51) Int. Cl. G06Q 10/00

(52) U.S. Cl. 705/7; 705/9

(57) ABSTRACT

Systems and methods for project management are provided for a project containing tasks and user designations for administrators and non-administrators. Each task has a task completion status and a task identity. Each respective user designation includes a user account associated with a user. The administrator can change the task completion status of all tasks whereas the non-administrator can only change the task completion status of some of the tasks in the project. A first electronic message is received from the administrator. The message assigns a task to a non-administrator. Subsequently, a second electronic message with a completion status of the task is received from the non-administrator, whereupon the completion status of the task in an electronically stored record of the project is updated to reflect the new completion status of the task without human intervention.

### 1. FIELD OF THE INVENTION

This invention relates to systems and methods for defining and managing task oriented projects.

### 2. BACKGROUND OF THE INVENTION

Managing task oriented projects is a challenging endeavor. A typical project has a number of tasks assigned to a various people. Each such task may have a due date. Furthermore, reminders are needed as tasks become due. The people assigned to the various tasks of a project are often not in the same organization. For example, many of the tasks in a project may be assigned to specialists, contractors, or vendors that are not part of the business entity or other form of organization that is managing or otherwise responsible for the completion of the task oriented project. Thus, for a typical task oriented project, there is often no central or common computer system that is shared by the people assigned to a project. And, even if all the people involved in a project were in the same business entity or other organization, complex and custom software would typically be required to manage the project.

There exists calendaring programs that can be used to check the availability of people at any given time and to propose and confirm meetings. However, calendaring programs are not well suited for the management of a task oriented project in which tasks have been assigned to different people. A calendaring program, such as those found in many modern E-mail software applications, keep track of the schedule of a single individual. They are not readily adaptable to use for assigning tasks to multiple users and keeping track of the status of such tasks.

Given the above background, what is needed in the art are improved systems and methods for defining and managing task oriented projects.

### 3. SUMMARY OF THE INVENTION

The present invention addresses the need arising in the art for improved systems and methods for defining and managing task oriented projects. A project administrator creates and defines a project using simple text based messages (e.g., E-mail messages) that are copied to the E-mail address or other electronic address of a project management module residing on a task management apparatus. For example, the E-mail message:

From: jim@xyz.com

To: george@xyz.com, martha@xyz.com

CC: t@onvoq.com

Subject: about Johnson Contract

1. Interview key suppliers assign to george 1/25/2008

2. Choose supplier assign to martha February 1

3. Choose marketing consultant, assign to me next Thursday

copies the E-mail address of the project management module (t@onvoq.com). The subject line of this E-mail message includes the command “about” followed by the phrase “Johnson Contract.” Thus, responsive to this E-mail, the project management module at t@onvoq.com creates a project comprising the three tasks delineated in the E-mail. The E-mail message is directed to george@xyz.com and martha@xyz.com. The project management module uses this information to automatically determine the address or identifier of tasks one and two. George, who is assigned to task one, is deemed to be addressable at the address or identifier george@xyz.com. Martha, who is assigned to task two, is deemed to be addressable at the address or identifier martha@xyz.com. The third task is deemed to be assigned to the sender of the E-mail, Jim, who can be reached at jim@xyz.com.

The exemplary E-mail further illustrates how each of the tasks can be assigned a task completion date (task due date). The format for this task completion date is flexible (e.g., 1/25/2008, February 1, next Thursday, etc.). The exemplary electronic communication set forth above is advantageous because it notifies Martha and Jim that they have been assigned tasks for a project while at the same time serving to initiate an electronic record of the project by a project management module. No special software is required by George, Martha, or Jim, other than conventional E-mail software which is ubiquitous and, moreover, constantly checked by many users all the time. While the tasks are numbered in the exemplary E-mail, such numbering is not required by the project management module. Any logical delineation of tasks, such as the use of a dash or star on a new line, can be used to delineate a new task or command in a project.

The administrator, Jim, can change the task completion status, the task completion date, the task description, the person the task has been assigned to, or delete any or all tasks in the project using simple commands sent to the project management module in one or more subsequent electronic communications such as E-mails. In contrast, Martha and George, who are not administrators, can change the task completion status of only the tasks to which they have been assigned. For example, George, upon receiving the above-identified E-mail may issue the following E-mail using the reply-to-all function of a standard E-mail program that George happens to use and check on a frequent basis:

Reply-to (all) . . .

Subject: re: about Johnson contract

1. change interview is done

The E-mail from George illustrates a number of advantages of the present invention. By using the reply-to-all function, the project management module, Martha as well as Jim are all notified by George that the interview of key suppliers is done. No specialized software is needed and the management of the Johnson contract project is easy. Conveniently, George does not have to replicate the entire name of the first task “Interview key suppliers,” just a unique portion of the first task, here simply the word “interview.” In response to the E-mail from George, the project management module updates the status of the task “Interview key suppliers” to done.

The present invention includes many additional features. For example, the status of a task in a project can be queried by a simple electronic communication (e.g., an E-mail message). For example, the E-mail

To: t@onvoq.com

Subject: status Johnson contract

serves as a query to the project management module for the status of each task in the Johnson contract project, to which the project management module responds with a reply E-mail, short message service (SMS) message, instant message, or other communication with the status of each of the tasks in the Johnson project. For instance, the project management module may respond to the E-mail above with:

Subject: status Johnson contract

1. Interview key suppliers, george@xyz.com, done

2. Choose supplier, martha@xyz.com, not done

3. Choose marketing consultant, jim@xyz.com, not done

This and other features useful for project management are provided by the present invention.

Now that an example of the present invention has been provided to introduce the many advantages and features of the present invention, some exemplary embodiments will now be more formally presented. One such exemplary embodiment provides a method for defining and managing a project on a task management apparatus. The project comprises a project identifier (e.g., “Johnson Contract”), a plurality of tasks, where each respective task in the plurality of tasks comprises a task completion status (e.g., done, not done) and a task identity (e.g., “Interview key suppliers,” “Choose supplier,” “Choose marketing consultant,” etc.). The project further comprises a designation of each user in a plurality of users (e.g., George, Martha, Jim, etc.), where the plurality of users comprises an administrator (e.g. Jim) and at least one non-administrator (e.g., George, Martha, etc.) and where each designation of a respective user in the plurality of users comprises an address or identifier of a user account associated with the respective user, such as an E-mail address, SMS address, instant messaging address, or Internet protocol address. The administrator can change the task completion status of each task in the plurality of tasks. The non-administrator can change the task completion status of a subset of the plurality of tasks (e.g., the subset of tasks to which the non-administrator has been assigned).

In the method, a first electronic message (e.g., an E-mail message) is communicated to the task management apparatus from a user account associated with the administrator. In some instances, this first electronic message comprises a task identity of each task in a plurality of tasks. In other instances, several electronic messages, each with one or more tasks, are communicated to the task management apparatus from the user account associated with the administrator in order to define the project. Typically, these electronic messages are sent to both the task management apparatus and to the people who have been assigned the tasks. In this way, the same communication can be used by the task management apparatus to build an electronic record of the project and to notify individual people that they have been assigned tasks. Thus, for this reason, the electronic messages may optionally include, as recipients, the addresses or identifiers of the user accounts associated with the non-administrators. Each of these electronic messages (e.g., the first electronic message) includes instructions for assigning one or more tasks to a non-administrator. Further, in the method, a record of the project defined in the above-identified one or more electronic messages is electronically stored on a task management apparatus by the project management module without human intervention upon receipt of the one or more electronic messages by the task management apparatus.

Subsequently, in the method, an electronic message is received at the task management apparatus from the user account associated with a non-administrator. In some instances, this electronic message is responsive to the first electronic message (or any of the messages from the administrator that defined or managed the project) and comprises an indication of a completion status of a task in the project. In some instances, the electronic message is not a direct reply to the administrator's message, but rather is a new electronic message (e.g., E-mail) that includes the identifier for the project and an indication of a completion status of a task in the project. Further, in the method, the completion status of the task in the electronically stored record of the project on the task management apparatus is updated without human intervention upon receipt of the electronic message by the task management apparatus from the user account associated with the non-administrator.

There is no limit to the number of projects that can be concurrently managed and tracked by the project management module (e.g., 10 or more projects, 100 or more projects, 1000 or more projects, a million or more projects, etc.). In exemplary embodiments, the particular project that a communication is referencing is indicated by the electronic communication (e.g., by the re: line of an E-mail). In some instances, one user may be the administrator of several different projects. In some instances, one user may by the administrator of some projects and a non-administrator of other projects. In some instances, one user may be a non-administrator of tasks in several different projects.

The present invention further discloses computer systems and/or apparatus that include instructions for executing any one of the methods disclosed herein. The present invention further discloses computer readable media for executing any one of the methods disclosed herein.

### 4. BRIEF DESCRIPTION OF THE DRAWINGS

FIG. 1 illustrates a computer system for defining and managing task oriented projects in accordance with an embodiment of the present invention.

FIG. 2 illustrates a method for defining and managing a task oriented project in accordance with an embodiment of the present invention.

Like reference numerals refer to corresponding parts throughout the several views of the drawings.

### 5. DETAILED DESCRIPTION

The present invention provides systems and methods for project management for one or more projects, where each project contains tasks and user designations for at least one administrator and at least one non-administrator. Each task in a project has a task completion status and a task identity. If a task completion status is not specified by the administrator for a given task when constructing the project, the default task completion status of “not done” is assumed for the given task. Each respective user designation for a project includes a user account associated with a user, such as an E-mail address for the user, a short message service (SMS) address for the user, an instant messaging address for the user, an internet protocol address for the user, etc. In typical embodiments, the user that is designated as the administrator of a project can change the task completion status of all tasks of the project whereas the users that are designated non-administrators can only change the task completion status of some of the tasks in the project.

In an embodiment of the present invention, an electronic message is received from the administrator and this electronic message also includes as recipients one or more non-administrators of the project. For example, Jim (jim@xyz.com) may send an E-mail message to the E-mail address of a project management module and copy George (george@xyz.com) and Martha (martha@xyz.com) on the communication. In the example, the electronic message assigns tasks to non-administrators (e.g., “Interview key suppliers assign to george 1/25/2008,” “Choose supplier assign to martha February 1,” etc.). However, it is not required that non-administrators be recipients to such communications. Non-administrators can obtain their tasks using the calendar and other information retrieval commands disclosed herein. Subsequently, an electronic message with a completion status of a task in a project is received from a non-administrator whereupon the completion status of the task in an electronically stored record of the project is updated to reflect the new completion status of the task without human intervention.

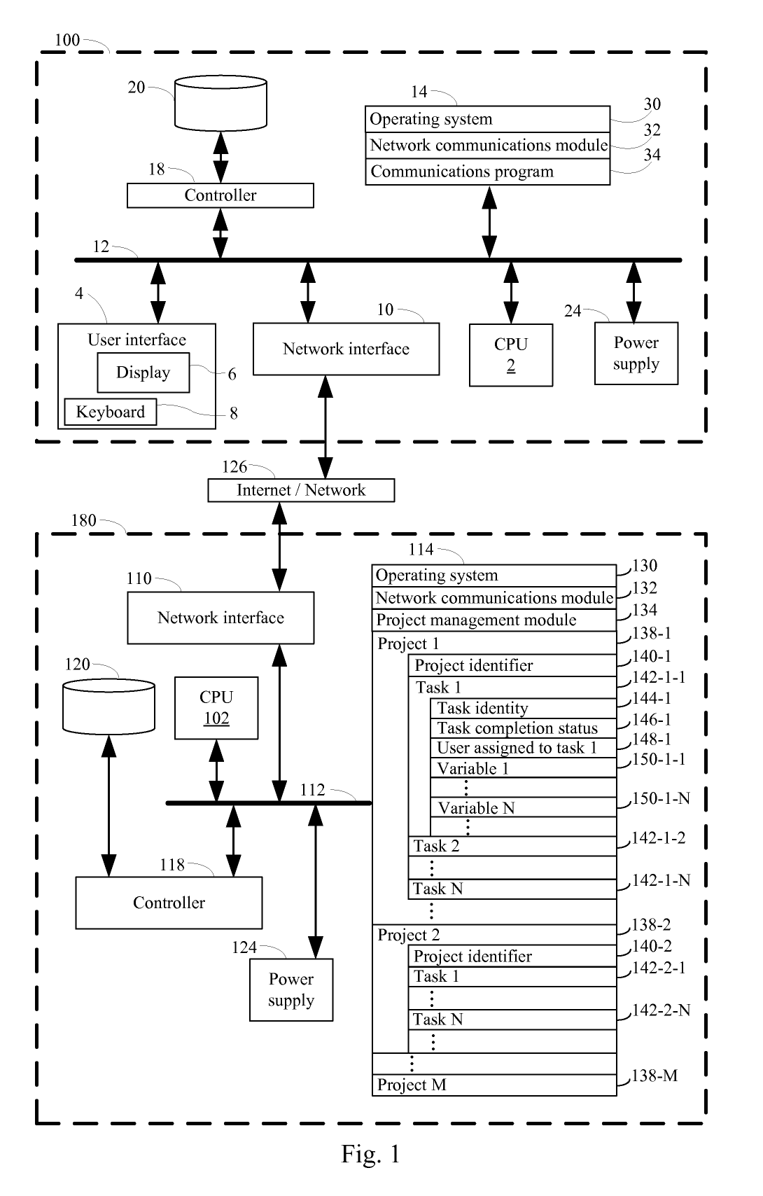

FIG. 1 illustrates a task management apparatus 180 in accordance with one embodiment of the present disclosure. In some embodiments, the task management apparatus 180 is implemented using one or more (not shown) computer systems. It will be appreciated by those of skill in the art that the task management apparatus 180 may use complicated computer architectures not shown in FIG. 1. For instance, a front end set of servers may be used to receive and distribute electronic messages (e.g., E-mail messages, SMS messages, etc.) from numerous client devices 100 among a set of back-end servers that actually process the electronic messages. In such a system, the task management apparatus 180 as shown in FIG. 1 would be one of many such back-end servers.

The task management apparatus 180 will typically have one or more processing units (CPU's) 102, a network or other communications interface 110, a memory 114, one or more magnetic disk storage devices 120 accessed by one or more controllers 118, one or more communication busses 112 for interconnecting the aforementioned components, and a power supply 124 for powering the aforementioned components. Data in memory 114 can be seamlessly shared with non-volatile memory 120 using known computing techniques such as caching. Memory 114 and/or memory 120 can include mass storage that is remotely located with respect to the central processing unit(s) 102. In other words, some data stored in memory 114 and/or memory 120 may in fact be hosted on computers that are external to the task management apparatus 180 but that can be electronically accessed by the task management apparatus 180 over an Internet, intranet, or other form of network or electronic cable (illustrated as element 126 in FIG. 1) using network interface 110.

Memory 114 preferably stores:
an operating system 130 that includes procedures for handling various basic system services and for performing hardware dependent tasks;
an optional network communications module 132 that is used for connecting the task management apparatus 180 to various client devices such as client devices 100 (FIG. 1) and possibly to other servers or computers via one or more communication networks, such as the Internet, other wide area networks, local area networks (e.g., a local wireless network can connect the client devices 100 to the task management apparatus 180), metropolitan area networks, and so on;
a project management module 134 for receiving instructions for defining and managing one or more projects on task management apparatus 180; and
a plurality of projects 138, each project comprising a project identifier 140 and a plurality of tasks 142, where each respective task 142 in the plurality of tasks comprises (i) a task identity 144, (ii) a task completion status 146, (iii) a designation of a user 148 in a plurality of users, and (iv) optionally, one or more data elements (variables) 150, with at least one user assigned to a task in a project 138 in the plurality of projects being an administrator and at least one user assigned to a task in the project 138 being a non-administrator.

As illustrated in FIG. 1, the task management apparatus 180 is connected via Internet/network 126 to one or more client devices 100. FIG. 1 illustrates the connection to only one such client device 100. However, in practice, the task management apparatus 180 can be connected to 10 or more client devices 100, or 100 or more client devices.

Each client device 100 can be a personal digital assistant or some other device (telephone with text messaging capabilities) associated with users assigned to project tasks. In typical embodiments, a client device 100 comprises:
one or more processing units (CPUs) 2;
a network or other communications interface 10;
a memory 14;
optionally, one or more magnetic disk storage devices (or other form of non-volatile memory) 20 accessed by one or more optional controllers 18;
a user interface 4, the user interface 4 including a display 6 and a keyboard or other form of input device 8;
one or more communication busses 12 for interconnecting the aforementioned components; and
a power supply 24 for powering the aforementioned components.

In some embodiments, data in the memory 14 can be seamlessly shared with the optional non-volatile memory 20 using known computing techniques such as caching. In some embodiments, the client device 100 does not have a non-volatile memory 20, or at least does not have magnetic non-volatile memory. In some embodiments, the client device 100 is a portable handheld computing device and the network interface 10 communicates with the Internet/network 126 by wireless means. Memory 14 preferably stores:
an operating system 30 that includes procedures for handling various basic system services and for performing hardware dependent tasks;
a network communication module 32 that is used for connecting client device 100 to the task management apparatus 180; and
a communications program (e.g. E-mail program, short message service program, instant message program, etc.) 34 for communicating electronic messages with management apparatus 180.

In some embodiments, E-mail is communicated between devices 100 and the task management apparatus 180 over the Internet using simple mail transfer protocol (SMTP). Other protocols for communicating e-mail between devices 100 and task management apparatus 180 include, but are not limited to, POP3, X.400 International Telecommunication Union standard (X.400), the Novell message handling service (MHS), and extended simple mail transfer protocol (ESMTP). Specifically, X.400 defines a transfer protocol for sending electronic mail and is used in Europe as an alternative to SMTP. MHS, which was developed by Novell, is used for electronic mail on Netware networks.

SMTP transports electronic mail among different hosts within the transmission control protocol/Internet protocol (TCP/IP) suite. Under SMTP, a client SMTP process opens a TCP connection to a server SMTP process on a remote host and attempts to send mail across the connection. The server SMTP listens for a TCP connection on a specific port (25), and the client SMTP process initiates a connection on that port. When the TCP connection is successful, the two processes execute a simple request-response dialogue, defined by the SMTP protocol (see RFC 821 STD 10, Simple mail transfer protocol, August 1982, for details), in which the client process transmits the mail addresses of the originator and the recipient(s) for a message. When the e-mail server process accepts these mail addresses, the client process transmits the e-mail message. The e-mail message contains a message header and message text (“body”) formatted in accordance with RFC 822 (RFC822 STD 11, Standard for the format of ARPA—Internet Text Messages, August 1982). Mail that arrives via SMTP is forwarded to a remote server or it is delivered to mailboxes on the local server. On UNIX-based systems, Sendmail is the most widely used SMTP server for e-mail. Sendmail includes a POP3 server and also comes in a version for Windows NT. Microsoft Outlook is the most popular mail-agent program on Window-based systems.

The SMTP model (RFC 821) supports both end-to-end (no intermediate message transfer agents “MTAs”) and store-and-forward mail delivery methods. The end-to-end method is used between organizations, and the store-and-forward method is chosen for operating within organizations that have TCP/IP and SMTP-based networks. A SMTP client will contact the destination host's SMTP server directly to deliver the mail. It will keep the mail item from being transmitted until it has been successfully copied to the recipient's SMTP. This is different from the store-and-forward principle that is common in many other electronic mailing systems, where the mail item may pass through a number of intermediate hosts in the same network on its way to the destination and where successful transmission from the sender only indicates that the mail item has reached the first intermediate hop. The RFC 821 standard defines a client-server protocol. The client SMTP is the one which initiates the session (that is, the sending SMTP) and the server is the one that responds (the receiving SMTP) to the session request. Because the client SMTP frequently acts as a server for a user-mailing program, however, it is often simpler to refer to the client as the sender-SMTP and to the server as the receiver-SMTP. An SMTP-based process can transfer electronic mail to another process on the same network or to another network via a relay or gateway process accessible to both networks. An e-mail message may pass through a number of intermediate relay or gateway hosts on its path from a sender to a recipient.

As illustrated in FIG. 1, the task management apparatus 180 comprises a number of data structures such as projects 138. These data structures can be in any form of data storage including, but not limited to, a flat file, a relational database (SQL), or an on-line analytical processing (OLAP) database (MDX and/or variants thereof). In some embodiments, these data structures are stored in a database that comprises a star schema that is not stored as a cube but has dimension tables that define hierarchy. Still further, in some embodiments, these data structures are stored in a database that has hierarchy that is not explicitly broken out in the underlying database or database schema (e.g., dimension tables that are not hierarchically arranged). In some embodiments, these data structure are stored on the task management apparatus 180. In other embodiments, some or all of these data structures are hosted on (stored on) one or more computers that are addressable by the task management apparatus 180 across Internet/network 126. In some embodiments, all or a portion of one or more of the program modules depicted in the task management apparatus 180 of FIG. 1 (e.g., network communication module 132, project management module 134, etc.) are in fact resident on a computer other than the task management apparatus 180 that is addressable by the task management apparatus 180 across Internet/network 126.

In the context of this application, a task 142 is understood to be any type of action item that can be assigned to a person. Often a task is best completed by a person that has specialized skills related to the task. For example, a promotional task is best handled by someone with marketing experience, a task related to procuring hardware to perform a specialized function is best handled by someone who has technical hardware experience, and so forth. Tasks are formed into hierarchical constructs termed “projects.” In other words, a project 138 comprises a plurality of tasks that are related to each other in a hierarchical fashion. There is no limit to the number of levels in this hierarchy. In some embodiments, there is only one level of hierarchy in which all of the tasks of a project are at the same hierarchical level and are associated with each other simply because they are in the same project. In other embodiments, one or more of the top level tasks in a project has child tasks. In still other embodiments, the plurality of tasks in a project may form three or more, four or more, five or more, ten or more or fifty or more levels of hierarchy.

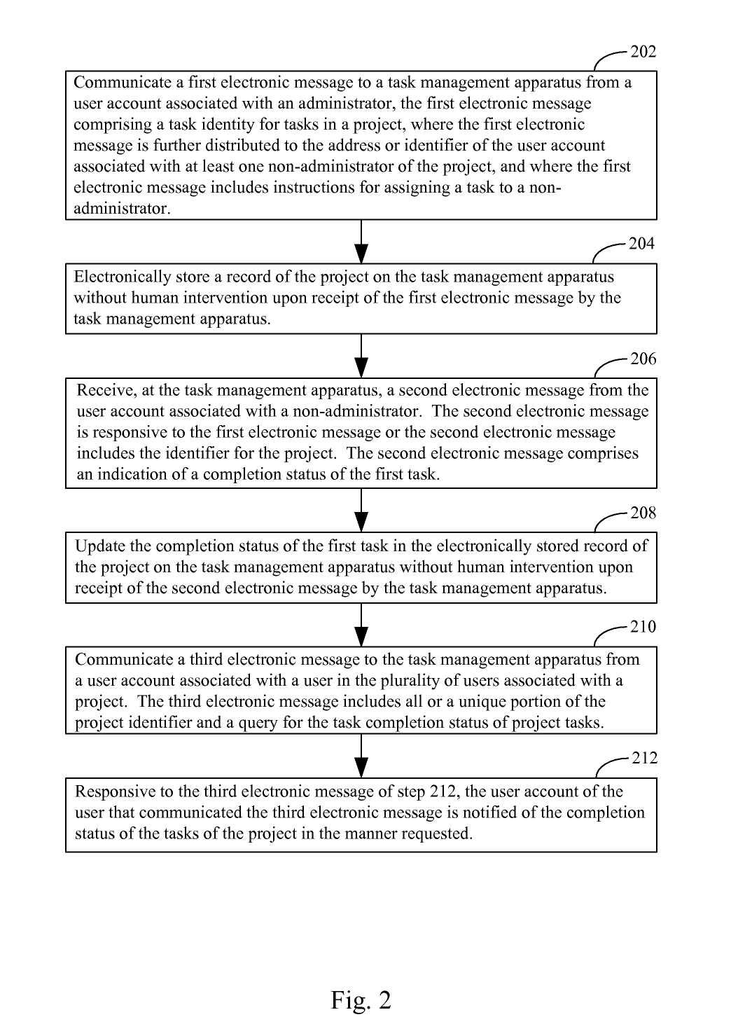

Now that exemplary computer systems in accordance with the present invention have been described, exemplary methods in accordance with the present invention will be detailed. Referring to FIG. 2, in step 202, a first electronic message is communicated to a task management apparatus from a user account associated with an administrator. This first electronic message comprises a task identity for tasks in a project, where the first electronic message is further distributed to the address or identifier of the user account associated with at least one non-administrator of the project. The first electronic message includes instructions for assigning a task to a non-administrator.

An exemplary first electronic message is:

From: jim@xyz.com

To: george@xyz.com, martha@xyz.com

CC: t@onvoq.com

Subject: about Johnson Contract

1. Interview key suppliers assign to george 1/25/2008

2. Choose supplier assign to martha February 1

3. Choose marketing consultant, assign to me next Thursday

In this exemplary first electronic message, Jim is the administrator and can change the task completion status of each task in the project. George and Martha are non-administrators. They can only change the task completion status of the tasks that have been assigned to them by Jim. Further, in this example, the first electronic message is in the form of an E-mail message. This exemplary electronic first message is communicated to the task management apparatus by CCing t@onvoq.com from the user account associated with the administrator jim@xyz.com). This exemplary first electronic message comprises a task identity for tasks in a project (“Interview key suppliers,” “choose supplier,” “choose marketing consultant”), where the first electronic message is further distributed to the address or identifier of the user account associated with at least one non-administrator of the project. The exemplary first electronic message includes instructions for assigning a task to a non-administrator (George, who is a non-administrator is assigned task 1 and Martha, who also a non-administrator, is assigned task 2).

In typical embodiments, a project 138 comprises a project identifier 140 (e.g., “Johnson Contract”), a plurality of tasks 142 where each respective task 142 in the plurality of tasks comprises a task completion status 146 (e.g., “not done,” “done”), and a task identity 144 (e.g., “Interview key suppliers,” “Choose supplier,” “Choose marketing consultant,” etc.). In some embodiments, if the electronic message from the administrator does not specify the task completion status 146, it is assumed by task management apparatus 180 that the task completion status 146 of a task 142 is “not done.”

A project includes a designation of each user in a plurality of users. Typically, as illustrated in FIG. 1 and consistent with the exemplary first electronic communication presented above, such users are associated with individual tasks (e.g., George assigned to task 1, Martha assigned to task 2, etc.) within the project 138. The plurality of users associated with any given project 138 comprises an administrator and a non-administrator. The administrator can change the task completion status of each task in the project whereas the non-administrator has the privilege to change the task completion status of only a subset of tasks in a project. Each designation of a respective user in a project comprises an address or identifier of a user account associated with the respective user (e.g., george@xyz.com, martha@xyz.com, etc.).

There is no requirement that the project administrator include a plurality of tasks in the first electronic message. However, a project is defined herein as comprising a plurality of tasks in which at least one task has been assigned to a non-administrator. A project administer can forward to the task management apparatus 180 multiple electronic messages that include tasks for a given project. Thus, when the first electronic message from the non-administrator includes only a single task, the deficiency can be remedied by subsequent electronic messages from the non-administrator that include additional tasks. The following provides an example in which administrator sends subsequent electronic messages in order to add tasks to the Johnson Contract project:

From: jim@xyz.com

To: susan@pdq.com

CC: t@onvoq.com

Subject: Johnson Contract

4. Select color scheme assign to Susan 3/2/2008

In this exemplary electronic communication, the task “Select color scheme” is added to the Johnson project and Susan, who is reachable at the address susan@pdq.com, is assigned to the project. This example further shows that not all the users assigned various tasks in a project need to be at the same corporation. Jim, George, and Martha are at xyz.com while Susan is at pdq.com.

Referring to FIG. 2, in exemplary step 204, a record of the project 138 is electronically stored on task management apparatus 180 without human intervention upon receipt of the first electronic message by the task management apparatus 180. Step 204 exemplifies an important advantage of the present invention. By simply copying or forwarding an electronic message to task management apparatus 180 (e.g., by using the designation CC: t@onvoq.com in and E-mail message), a record of the project is automatically stored by the task management apparatus. Various users that are responsible for completion of the tasks in the project can communicate with each other and, if these electronic communications are copied or otherwise communicated to task management apparatus 180, task management apparatus 180, and more particularly project management module 134, will track the status of the project. This dynamic process of updating a project 138 is exemplified by step 206 of FIG. 2, in which there is received, at the task management apparatus 180, a second electronic message from the user account associated with a non-administrator. The second electronic message is responsive to the first electronic message (e.g., is a reply E-mail) or the second electronic message includes the identifier for the project (e.g., the second electronic message is an E-mail message that says “Subject: Johnson Contract” in the Re line of the E-mail message). The second electronic message comprises an indication of a completion status of the first task. An example of such a second electronic communication that is an E-mail and that is responsive to the first electronic message is:

Reply-to (all) . . .

Subject: re: about Johnson contract

interview is done

In this example, the E-mail is originated from george@xyz.com, who has been assigned task 1 “Interview key suppliers” by Jim. The example illustrates that the second electronic communication does not have to spell out the complete task identity of the task that is being updated. George simply states “interview is done.” In response to the second electronic communication, project management module 134 intelligently determines that the communication pertains to the Johnson contract project 138 because the re line includes the terms “Johnson contract” and that the status of the task 142 having the task identity 144 of “Interview key suppliers” is done.

In the example above, the phrase “interview” is an example of what is termed a “unique portion.” Generally speaking, a unique portion of a phrase is that portion of the phrase that allows for the phrase to be uniquely identified from among a plurality of phrases associated with a given project. For instance, a unique portion of a task identity 144 of a given project 138 is a sufficient portion of the task identity 144 phrase that will uniquely identify the task from among all the tasks 142 of the given project 138. The phrase “interview” is a unique portion of the task identity “Interview key suppliers” if no other task 142 in the given project 138 contains the term “interview.” In the example, the term “Johnson Contract” identifies the root task (project). Thus, the term “interview” need only be unique within the subtasks of the “Johnson Contract.” Indeed, there may be many “interview tasks accessible by a given user, but presumably only one among “Johnson Contract” subtasks. In other words, individual tasks act as if they have the identifiers of all the parent tasks down to the root. They can be uniquely identified by any unique combination of identifiers in that set of identifiers. The net effect is that identifiers make use of task hierarchies in a project and can use the hierarchical structure to disambiguate task identity.

In step 206, it was noted that the second electronic message can be responsive to the first electronic message or the second electronic message can include the identifier for the project. An example in which the second electronic message is not a reply to the first electronic message is the following E-mail message from George:

From: george@xyz.com

CC: t@onvoq.com, jim@xyz.com

Subject: Johnson

interview is done

In the example, by copying the address t@onvoq.com, the project management module 134 is notified of the update to the Johnson Contract project. Project management module 134 intelligently scans the electronic communication and determines that the term “interview” on a separate line of the communication refers to the “Interview key suppliers” task 142.

Referring to step 208 of FIG. 4, in response to the electronic communication received in step 206, the project management module 134 of the task management apparatus 180 updates the task completion status 146 of the first task in the electronically stored record of the project 138 on the task management apparatus 180 without human intervention.

As the examples above illustrate, in some embodiments, the first electronic message of step 202 is an E-mail message and the user account associated with the administrator (e.g., Jim) of a project is an E-mail account (e.g., jim@xyz.com). In some embodiments, the first electronic message is any form of electronic communication (e.g., it does not have to be E-mail). In some embodiments, the second electronic message of step 206 is an E-mail message, a Short Message Service (SMS) message, an instant message, or an Internet communication.

Any of the tasks 142 of a project 138 can include one or more subtasks. Such subtasks are created by sending an electronic communication to project management module 134, similar to the examples above, with an implied or explicit create command (e.g., create, construct, new, etc.). In some embodiments, the command is “create” and has the format:
create|cr what task [symbol] data . . . [symbol] notes [symbol] subtasks
   where [symbol] stands for carriage return, “what task” is the task identity 144 or a unique portion of the task identity, and “data” is one or more lines in which data is associated with one or more variables 150 of tasks 142. In preferred embodiments, there is one data assignment to a variable 150 per line using the following format:
field=value
   The field (variable 150) can be a single word or a phrase in quotes. The value is any text and extends to the end of the line. If the text contains commas, it is interpreted as a list of values. If a line ends with a comma, it interpreted as a list of values that continues on the next line. Examples of such assignments include:

rating=5

“marketing consultant”=mjones@xyz.com

equipment=scissors, paper, glue,

paint, thumb tacks

The last example created a list of five elements. A user can add or remove values using + or −. For example the commands:

“marketing consultant”−mjones@xyz.com

equipment+popsicle sticks, paper clips

may be used when the user Mjones will no longer be assigned the marketing consultant task of a project and two items are added to the equipment list so that is now contains seven elements: scissors, paper, glue, paint, thumb tacks, popsicle sticks, and paper clips. The variables 150 can be used in commands other than the create command. Generally speaking, the variable 150 is a user-defined data field comprising a field name, an optional range specifying expected values, and a value.

In the syntax for the create command, “notes” are discussion comments added to tasks consisting of arbitrary text. Notes are an advantageous feature because the project administrator or other users assigned to tasks in a project can add notes to a task that pertain to the task and such notes will be associated with the correct project 140 by project management module 134. In this fashion, notes form a history of comments made in conjunction with a task. Notes can be used, for example, to explain changes made to the tasks of a project (e.g., why a due date was changed). Task listings can include these notes so that users can review the history of a task. Users can also use this as a mechanism for task discussion—a set of back-and-forth comments, questions, and answers.

In the syntax for the create command, “subtasks” are specified using a bullet mechanism. In preferred embodiments, several varieties of bullets can be used to designate subtasks including, but not limited to, digits (1.xxx), letters (a.xxx), stars (*xxx), dashes (−xxx), greater than symbols (>xxx). Moreover, subtasks can be nested for sub-sub-tasks, etc., (e.g., 1.2.e or 1.b.2, or with alternating conventions on the levels.) Each subtask is its own create command, only without an explicit “create” command. The following are examples of the creation of tasks in the Johnson Contract project that include subtasks:

create johnson contract task

1. setup marketing plan task due Mar. 23, 2008

gather requirements task assign to mark@xyz.com

budget authorization task assign to sally

budget=?

This can be tricky. Get Dave in accounting to help.

2. write pitch task assign to julie

a. rough draft task due 2/27

b. final approval task due 3/15

In the example above, two tasks 142 are created in the Johnson Contract project: “setup marketing plan” and “write pitch.” The first task (“setup marketing plan”) is due Mar. 23, 2008, but is not assigned to any particular user. Rather, two subtasks under the first task are created, “gather requirements” and “budget authorization,” and these subtasks are assigned to different users (Mark and Sally). The first task further includes a data element (variable 150) called budget and a note “This can be tricky. Get Dave in accounting to help.” The second task includes two subtasks “rough draft” and “final approval” each with a different task due date.

In some embodiments, a task can have one designated completion date and a subtask in the one or more subtasks of this task can comprise a subtask completion date that is different than the task completion date of the parent task. In some embodiments, the one or more subtasks comprise a plurality of subtasks and a first set of electronic instructions from an administrator are received (e.g., by project management module 134) that are operative to assign a first subtask in the plurality of subtasks to a first user in a plurality of users associated with a project without user intervention. Further, a second set of electronic instructions from the administrator are received (e.g., by project management module 134) that are operative to assign a second subtask in a plurality of subtasks to a second user in the plurality of users associated with a project without user intervention. As in the example above, the first set of electronic instructions and the second set of electronic instructions can be in the same electronic message. But this is not required. For example, the first and second set of electronic instructions can be in different electronic messages sent by a project administrator to project management module 134.

Referring to FIG. 2, in some embodiments, the first electronic message of step 202 is an E-mail message that includes a designation of each user in a plurality of users associated with the project in an electronic distribution list. In such embodiments, the electronic distribution list can comprise the address or identifier of a user account associated with a non-administrator of the project. For instance, in the electronic message:

From: jim@xyz.com

To: george@xyz.com, martha@xyz.com

CC: t@onvoq.com

Subject: remember Johnson Contract

1. Interview key suppliers assign to george 1/25/2008

2. Choose supplier assign to martha February 1

3. Choose marketing consultant, assign to me next Thursday

the electronic distribution list is “george@xyz.com, martha@xyz.com.” In some embodiments, the project management module 134 can use this electronic distribution list to determine the user accounts associated with George and Martha, who are non-administrators of the Johnson Project. In some embodiments, the list of message recipients is examined and the inference is made that “George” must be associated with the address george@xyz.com. In some embodiments, there is a list of known correspondents for a given user, and “George” is found in this list.

Steps 202 through 208 of FIG. 2 represent core steps associated with management of a project. Of course, the steps need not occur precisely in the order set forth in FIG. 2. For instance, the administrator may send any number of messages to project management module 134 regarding a specific project before a non-administrator sends a message to project management module 134 relating to the project. In step 210, an optional additional step associated with project management is performed: checking the status of a project. Thus, in exemplary step 210, a third electronic message is communicated to the task management apparatus from a user account associated with a user in the plurality of users associated with a project. The third electronic message includes all or a unique portion of the project identifier for the project and a query for the task completion status of a task in the plurality of tasks of the project. An example of this third electronic message is the send family of commands that collectively have the syntax:
[status|s]|[get|g]|[details]|[news][of] what task [now (default)|frequency|email]
   These commands send a report at varying levels of detail. Receipt of the “status” command causes project management module 134 to provide an electronic reply that lists task status, user assignees and due dates of a specified project or specified tasks within a project. Receipt of the “details” command causes project management module 134 to provide task status, user assignees, due dates, and notes of a specified project or specifies tasks within a project. Receipt of the “news” command causes project management module 134 to provide a listing with just recent or unseen notes in a specified project or associated with specified tasks within a project. The frequency parameter can be used to set up recurring reports (e.g., daily, weekly, monthly, etc.) in which an optional mode, now, the default, sends the report as soon as project management module 134 processes the request. Examples of the send family of commands are:

status johnson contract tasks

news johnson contract tasks every Monday 7 am email

get Johnson contract assigned to bking@xyz.com tasks

The first command returns the status of all tasks in the Johnson contract project, regardless of due date or assignee. The second command returns updates on tasks within the Johnson contract project every Monday morning. The third command returns a list of all tasks in the Johnson contract project assigned to bking@xyz.com. Responsive to any of these commands, in step 212, the user account of the user that communicated the third electronic message of the task is notified of the requested information in the manner requested.

Other steps that can be performed in addition to or instead of steps 210 and 212 are steps designed to set up project reminders. For example, in some embodiments of the present invention, electronic message is communicated to the task management apparatus 180 from a user account associated with a user in the plurality of users of project. This electronic message includes all or a unique portion of the project identifier and a task reminder for a task in the plurality of tasks of the project. Responsive to this electronic communication, the task management apparatus 180 provides the user account of the user that communicated the electronic message a reminder at the predetermined time designated by the electronic message. This user can be an administrator or a non-administrator. In some embodiments, the syntax of the reminder command in the electronic message is:
remind|r[me][about] what task [at[date]time]|[in duration]|[duration before][sms|email]
   As set forth in the syntax above, the remind command is a request to send a reminder about an event or task due date, either at a fixed time, or a time relative to the event or task due date. The reminder can be sent by E-mail, short message service (SMS) message, instant message, or by other communication means. Examples of the remind command are:

remind me about johnson contract budget authorization tasks at 3 pm today

remind me about johnson pitch rough draft task two days before email

r johnson pitch rough draft task in 2 weeks

In the first example, a reminder regarding the task “budget authorization” in the “Johnson Contract” project is requested to be prepared and sent at 3 PM. In the second example, a reminder regarding the task “rough draft” in the “Johnson Contract” project is requested to be prepared and sent by E-mail two days before the task completion date for the “rough draft.” In the third example, a reminder regarding the task “rough draft” is requested two weeks from the date the reminder is made.

Still another command that can be included in electronic messages sent to the task management apparatus 180 and to other users in a project are requests for information about all tasks that are due in a given date range. For instance, in one embodiment an electronic message is communicated to the task management apparatus from a user account of a user in the plurality of users associated with a project. This electronic message includes all or a unique portion of the project identifier of project and a request for all due dates for tasks in the plurality of tasks of the project within a date range specified by the third electronic message. Responsive to this electronic message, all due dates for tasks in the plurality of tasks within a date range specified by the electronic message are communicated to the sender of the electronic message. In some embodiments, the syntax for such a request is:
calendar|c|cal [what task] date range [now (default)|frequency][sms|email]
   As set forth above, the calendar command sends a list of all tasks due in the given date range. The tasks can be restricted to just those matching what. In some embodiments, the command also adds overdue tasks. The calendar command can be scheduled. Examples of the calendar command are:

c Johnson contract tasks today sms

cal this week every Monday 8 am email

The first exemplary calendar command immediately sends by SMS all assignments due today for Johnson contract tasks. The message would also note Johnson contract late items assigned to so the sender of the calendar command. The second exemplary calendar command sets up a regular email of all tasks that are assigned to the sender of the calendar command on a weekly basis on Monday mornings, including late items, regardless of which project the task are in. Thus, if the user sending the calendar command has been assigned tasks in several different projects that are due during the time frame specified by the calendar command, the reply communication would include each of these tasks. As noted herein, tasks can be identified by keywords or phrases. But they can also be identified by replying to a task listing communication (e.g., the response given by project management module 134 when the model receives a calendar command). If a user replies to such a task listing, the user can refer to tasks simply by the corresponding sequential number in the listing, with no need to reference the standard identifier (keyword/phrase).

Still another command that can be included in electronic messages sent to the task management apparatus 180 by the administrator and to other users in a project are requests to reassign tasks. For instance, in one embodiment an electronic message is sent to the task management apparatus 180 from a user account associated with the administrator that includes all or a unique portion of the project identifier and instructions for reassigning a task from a first user to a second user. Responsive to this electronic communication, the project management module 134 reassigns the task to the second user. In some embodiments, the request has the syntax:
change|ch what task [done|later] due assign data . . . [symbol] notes
   In fact, as noted in the command syntax, the administrator of a project can use an electronic communication to change not only who is assigned a task but also the task completion status, the task due date, and/or data values. The administrator of a project can also add a note. In some embodiments, the non-administrator that has been assigned a task can change the task completion status, data values (variables), as well as add notes. The following are examples of the use of the change command:

change johnson contract budget authorization task done

change johnson rough draft task due date 3/2

change johnson budget authorization task

budget=25000

The first example marks a task as done, the second changes the due date, and the third sets the budget variable 150 to the value 25000.

Still another command that can be included in electronic messages sent to the task management apparatus 180 by the administrator and to other users in a project is a requests to delete tasks. For instance, in one embodiment an electronic message is sent to the task management apparatus 180 from a user account associated with the administrator that includes all or a unique portion of the project identifier and instructions for deleting a task from a project. Responsive to this electronic communication, the project management module 134 deletes the task from the project. In some embodiments, the request has the syntax:

delete what task

Once a task has been deleted, it will not show up on reports. Regular reports on that task are removed. Further, once a task has been deleted, it cannot be changed or modified. Deletion of a task also deletes any child tasks (e.g., subtasks). An example of such a deletion command is:

delete Johnson contract budget authorization task

in which the budget authorization task is deleted from the Johnson contract.

Still another command that can be included in electronic messages sent to the task management apparatus 180 by users assigned to tasks in one or more project is a “my updates” request having the format:

my updates|m what

In response to receipt of this command in an electronic communication, project management module 134 lists all scheduled updates that match the what expression. The message recipient can reply to this list to forget particular reports, optionally replacing them with different reports. For instance, in response to the command:

my updates johnson contract tasks

an exemplary embodiment of project management module 132 would send a reply having the following format:

1. list johnson contract late tasks daily sms

2. news for john contract tasks weekly email

The recipient could remove the second report by specifying:

Reply to . . .

delete 2.

In some embodiments, another command that can be used in electronic messages sent to project management module 134 by project users is the “about” command. In some embodiments, the about command has the syntax:
about what task data . . . [symbol] subcommands [symbol] notes
   About is a way to specify a task or set of tasks for other operations. As a convenience, if an about command specifies a single task, it can add a note. Here are some examples:

about the Johnson Contract

list late tasks daily sms

details about tasks weekly email

This is equivalent to

list Johnson contract late tasks daily sms

details of johnson contract late tasks weekly email

In some embodiments, another command that can be used in electronic messages sent to project management module 134 by project users is the “help” command. In some embodiments, the help command has the syntax:
help|h[command, phrase, . . . ]
   In response to the help command, project management module 134 sends a message explaining the specified command. Project management module 134 examines the phrase and analyzes what, if anything, might be wrong with the phrase. Then project management module 134 sends a best guess of the correct version, along with an explanation of the command. Two examples of the help command are:

help create

help cal johnson contract today

In response to the first command, project management module 134 replies with help on the create command. In response to the second command, project management module 134 analyzes the phrase “cal johnson contract today” to guess what the user meant and would reply with:

It could be that you omitted “task” or “tasks”. In that case:

“cal johnson contract today” could mean “cal johnson contract tasks today”

. . . explanation about calendar syntax . . .

It is noted that the syntax of many of the exemplary commands presented herein include a what expression that specifies the task or set of tasks for the command. In simple cases, what is the task's name. This is its use in the create command. For other commands, the what expression can function as search, specifying all tasks whose name contains specific words or phrases, enabling commands to operate over the entire set of matching tasks. In some embodiments, project management module 132 also interprets the what expression in terms of task hierarchies. For example, if a parent task is named “Johnson contract” and a child task is named “get marketing requirements,” the phrase Johnson marketing requirements would match the child task. The what expression also includes due date or range and task assignees. These are identified by a due or assign component. For most commands, the what expression is followed by a task component that serves to end the what expression and transition to the next command parameter.

The what expression also works in conjunction with the about expression that has been described above. The what in an about command links to the what in commands that follow. Because of this, the statements:

about Johnson contract

change marketing requirements task to done

are equivalent to the statement:

change Johnson contract marketing requirements to done

The first form is useful for messages with multiple commands on related tasks. In some embodiments, message replies from project management module 134 work like an automatic about. In some embodiments, each message generated by project management module 134 numbers the tasks included in the message. A reply to a message from management module 134 can contain commands that include the message number in the what expression to operate on the corresponding task. A user can add further words or phrases to specify child tasks of the numbered task. If the original message to project management module 134 concerned just one task, commands in the reply from project management module 134 automatically focus on that task without necessarily including a task number.

Additional command parameters have been discussed above in terms of how they relate to particular commands. The syntax for these commands in an exemplary embodiment is provided in the following table:

| Exemplary command | |
|---|---|
| parameter | Description |
| Task | task, tasks, event, events or with qualifiers: late tasks, done |
| | tasks, tasks assigned to id, tasks due [on] date range |
| Id | A person: me, email address, email name (if available from |
| | context), or sms number. |
| Date | Date. May be explicit (Apr. 5, 2008) or relative (next week). |
| | Recognizes wide range of formats and common phrases. |
| date range | Two dates separated by to or a dash (-), or named range: today, |
| | tomorrow, this week, next week, this month, . . . |
| Time | An explicit (3:46 pm, or 6 am) or named time (noon, midnight) |
| Duration | Number of minutes, hours, days, . . . (2 days, one hour, 15 |
| | minutes, two weeks) |
| frequency | How often: daily, weekly, monthly, every Wednesday, first day |
| | of the month |
| Due | When a task is due, or range of due dates: [due [on]] date\|date |
| | range |
| Assign | Task assignee: assign [to] id |
| Range | Possible values for data: number to number or (choice 1, choice |
| | 2, . . .) |
| Notes | Discussion comments added to tasks consisting of arbitrary |
| | text. |

### 6. EXAMPLES

Exemplary short examples of commands that can be sent to project management module 132 are as follows:

Create choose printer task due March 31 at 3 pm, assign to mark@xyz.com, place=conference room A

Must be able to handle large orders on short notice.

News about choose printer task sms

Details about choose printer task, weekly email

Remind me about choose printer task 30 min before

Calendar this week email every Monday

Change the choose printer task, assign to shiela@xyz.com

Shiela knows the printing business very well.

Delete the change printer task

find choose printer task caterer

TASK CREATION. The following are examples of task creation.

The statement:

create Johnson contract task due 10/4/2008, 4:30 pm, assign to joe@xyz.com

creates a task entitled “Johnson contract,” due Nov. 4, 2008 at 4:30 PM, and assigns the task to joe@xyz.com.

The statements:

new meeting Johnson contract

due 10/4/2008, 4:30 pm, assign to joe@xyz.com

is like the first statement, but with different formatting and specifies a meeting rather than a task.

The statement:

cr t Johnson contract due 10/4/2008 assign to joe@xyz.com

uses an abbreviation “cr t” to create a task.

The statements:

create meeting Johnson contract

due 10/4/2008, 4:30 pm, assign to joe@xyz.com

worth (10000-50000)=?

‘max cost’=5000

create a meeting with associated data. The variable 150 entitled worth has a defined range, but no value. This signals the user Joe that he should get an evaluation of the potential contract value. He can update the meeting and provide a value at any time.

The statement:

meeting review contract due 10/4/2008, 4:30 pm, assign to joe@xyz.com

creates a meeting without using an explicit “create ” command.

The statement:

meet to review contract due 10/4/2008, 4:30 pm, assign to joe@xyz.com

also creates a meeting without using an explicit “create” command, but with slightly different syntax.

GET A TASK LISTINGS OR CALENDARS. The following are examples of getting a task listing or the user of the calendar command.

The statement:

show Johnson contract tasks due 10/4/2008, assigned to joe@xyz.com

asks for a listing of Johnson contract tasks due on a particular day and assigned to Joe.

The statement:

sh t Johnson contract due 10/4/2008 to 10/11/2008, assigned to joe@xyz.com asks for a listing of Johnson contract tasks due over a range of dates.

The statement:

show late tasks

asks for a listing of all late tasks accessible to the sender of the electronic message that includes the statement.

The statement:

sh late tasks

asks for a listing of all late tasks accessible to the sender of the electronic message that includes the statement in a more terse format.

The statement:

sh late sms

asks for a listing of all late tasks accessible to the sender of the electronic message that includes the statement in a more terse format and, responsive to this command, project management module 134 sends the output to SMS.

The statement:

sh late Johnson contract sms

asks for a listing of all late tasks related to the Johnson contract project and, responsive to this command, project management module 134 sends the output to SMS.

The statement:

sh details done Johnson contract assigned to joe email

gets a review of what the user Joe has completed lately.

The statement:

sh details finished Johnson contract tasks assigned to joe, sue@xyz.com, max due 3/14-3/21 email

gets a review of what Joe, Sue, and Max have completed for a specific range of dates.

The statement:

sh details done Johnson contract assigned to joe, sue@xyz.com, max due 3/14 8 am-3/21 9:30 pm email

is a syntactic variant of the above, but with times and not just dates in the date ranges.

CHANGE A TASK The following use of the change command.

The statement:

change Johnson contract assign to joe

assigns a task entitled “Johnson contract” to Joe.

The statement:

change Johnson contract assign to joe worth=25000

Assigns a task entitled “Johnson contract” to Joe and asserts its worth to 25000.

The statements:

change Johnson contract done

Everyone did a great job handling a really difficult customer

changes the designation of the “Johnson contract” to done and provides an attached note thanking everyone.

The statements:

change Johnson contract assign to joe, due March 25, worth=25000

I believe 25000 is a more realistic potential for this client after talking with their CEO

assigns the Johnson contract to Joe and adds a note about why the contract is worth 25000.

DELETE TASKS. The following are examples of task deletion.

The statement:

delete completed Johnson contract tasks assigned to joe

deletes Johnson contract tasks assigned to Joe.

The statement:

delete finished Johnson contract tasks due 2/1-3/31 assigned to joe

deletes Johnson contract tasks assigned to Joe that are due between 2/1and 3/31.

REMIND ME ABOUT TASKS. The following are examples of reminders.

The statement:

remind me about late Johnson contract tasks assigned to joe

provides a report on which Joe tasks assigned to Joe that are now late

The statement:

r done Johnson contract tasks due 2/1-3/31 assigned to joe

provides a report on what tasks assigned to Joe in the Johnson contract project that are due in February and March

The statement:

remind me about late Johnson contract tasks assigned to joe in 3 hrs is a request for a report in three hours on what tasks assigned to Joe in the Johnson contract project that are due in February and March.

The statement:

remind me about late Johnson contract tasks assigned to joe tomorrow at 9:30 is a request for a report tomorrow at 9:30 on what tasks assigned to Joe in the Johnson contract project that are late.

The statement:

remind me tomorrow morning at 9:30 about late Johnson contract tasks assigned to joe

is also request for a report tomorrow at 9:30 on what tasks assigned to Joe in the Johnson contract project that are late, with different syntax.

A TASK WITH TWO SUBTASKS. The following is an example of a task with two subtasks:

create task Johnson contract due 4/5/2008, 4:30 pm, assign to joe@xyz.com

This is a great opportunity. Let's make the most of it.

*meeting to review proposal due 3/10/2008, 9 am, assign to sue

We need a complete report on client expectations.

Also, do an advance check on printer availability for late March

*task interview photographers due 3/12/2008, assign to pete@xyz.com

price (2000-3000)=?

Get someone who knows southern Florida

The above set of statements creates a task called the Johnson contract, but gives it two sub-tasks: setting up a meeting to review the contract proposal, and interviewing photographers. The main task and each sub-task have attached notes. These can be reviewed at any time via task listings (show commands).

AN ABOUT TASK SPECIFYING CHANGES The following is an example of an about task specifying changes:

about task Johnson contract due 4/5/2008, 4:30 pm

change due 4/12/2008, 5:00 pm

Push the date back to accommodate new requirements.

change requirements review assign to sue@xyz.com

Sue has more experience with clients who can't make up their minds.

The above set of statements use an about task to provide context for child requests. Here, the about command specifies a specific task and the children specify changes to that task, one changing the due date, the other changing the assignee.

### 7. CONCLUSION

The present invention can be implemented as a computer program product that comprises a computer program mechanism embedded in a computer readable storage medium. Further, any of the methods of the present invention can be implemented in one or more computers or computer systems or other forms of apparatus. Further still, any of the methods of the present invention can be implemented in one or more computer program products. Some embodiments of the present invention provide a computer system or a computer program product that encodes or has instructions for performing any or all of the methods disclosed herein. Such methods/instructions can be stored on a CD-ROM, DVD, magnetic disk storage product, or any other computer readable data or program storage product. Such methods can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. Such methods encoded in the computer program product can also be distributed electronically, via the Internet or otherwise, by transmission of a computer data signal (in which the software modules are embedded).

All references cited herein are incorporated herein by reference in their entirety and for all purposes to the same extent as if each individual publication or patent or patent application was specifically and individually indicated to be incorporated by reference in its entirety for all purposes.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed:

1. A method for defining and managing a project on a task management apparatus, wherein the project comprises:
a project identifier;
a plurality of tasks, wherein each respective task in the plurality of tasks comprises a task completion status and a task identity; and
a designation of each user in a plurality of users; wherein the plurality of users comprises an administrator and a non-administrator and wherein each designation of a respective user in the plurality of users comprises an address or identifier of a user account associated with the respective user, wherein
the administrator has a privilege to change the task completion status of each task in the plurality of tasks;
the non-administrator has a privilege to change the task completion status of a subset of the plurality of tasks; and
the non-administrator does not have a privilege to change the task completion status of each task in the plurality of tasks that is not in the subset of tasks; and
the method comprises:
(A) communicating a first electronic message to the task management apparatus from a user account associated with the administrator, the first electronic message comprising a task identity of each task in the plurality of tasks, wherein the first electronic message optionally includes as a message recipient the address or identifier of the user account associated with the non-administrator, and wherein the first electronic message includes instructions for assigning a first task in the subset of tasks to the non-administrator;
(B) electronically storing a record of the project on the task management apparatus without human intervention upon receipt of the first electronic message by the task management apparatus in said communicating step (A);
(C) receiving, at the task management apparatus, a second electronic message from the user account associated with the non-administrator, the second electronic message responsive to the first electronic message or the second electronic message including the identifier for the project, the second electronic message comprising an indication of a completion status of the first task; and
(D) updating the completion status of the first task in the electronically stored record of the project on the task management apparatus without human intervention upon receipt of the second electronic message by the task management apparatus.

2. The method of claim 1, wherein
the first electronic message is an E-mail message, Short Message Service (SMS) message or instant message; and
the user account associated with the administrator is an E-mail account, a SMS account, or an instant message screen name.

3. The method of claim 2, wherein the second electronic message is an E-mail message, a Short Message Service (SMS) message, an instant message, or an Internet communication.

4. The method of claim 1, wherein a second task in the plurality of tasks comprises one or more subtasks.

5. The method of claim 4, wherein the second task further comprises a task completion date and a subtask in the one or more subtasks comprises a subtask completion date that is different than the task completion date.

6. The method of claim 4, wherein the one or more subtasks comprise a plurality of subtasks and wherein the method further comprises:
(i) receiving a first set of electronic instructions from the administrator that are operative to assign a first subtask in the plurality of subtasks to a first user in the plurality of users without user intervention; and
(ii) receiving a second set of electronic instructions from the administrator that are operative to assign a second subtask in the plurality of subtasks to a second user in the plurality of users without user intervention.

7. The method of claim 6, wherein the first set of electronic instructions and the second set of electronic instructions are in the first electronic message.

8. The method of claim 6, wherein at least one of (i) the first set of electronic instructions and (ii) the second set of electronic instructions are in an electronic message other than the first electronic message received by the task management apparatus from the user account associated with the administrator.

9. The method of claim 1, wherein the first electronic message is an E-mail message and wherein the designation of each user in the plurality of users in the project is obtained from an electronic distribution list associated with the first electronic message, wherein the electronic distribution list associated with the first electronic message comprises the address or identifier of the user account associated with the non-administrator.

10. The method of claim 1, wherein a second task in the plurality of tasks comprises a task completion date.

11. The method of claim 1, the method further comprising:
(E) communicating a third electronic message to the task management apparatus from a user account associated with a user in the plurality of users, the third electronic message including all or a unique portion of the project identifier and a query for the task completion status of a task in the plurality of tasks of the project; and
(F) notifying the user account of the user that communicated the third electronic message of the task completion status of the task.

12. The method of claim 1, the method further comprising:
(E) communicating a third electronic message to the task management apparatus from a user account associated with a user in the plurality of users, the third electronic message including all or a unique portion of the project identifier and a task reminder for a task in the plurality of tasks of the project; and
(F) sending a reminder to the user account of the user that communicated the third electronic message at a predetermined time designated by the third electronic message.

13. The method of claim 1 wherein the first electronic message further comprises a task reminder for a task in the plurality of tasks of the project, the method further comprising:
(E) sending a reminder to the user account associated with the administrator at a predetermined time designated by the first electronic message.

14. The method of claim 1, wherein one or more tasks in the plurality of tasks comprises a due date provided by the administrator, the method further comprising:
(E) communicating a third electronic message to the task management apparatus from a user account associated with a user in the plurality of users, the third electronic message including all or a unique portion of the project identifier and a request for all due dates for tasks in the plurality of tasks within a date range specified by the third electronic message; and
(F) sending, responsive to the third electronic message, all due dates for tasks in the plurality of tasks within a date range specified by the third electronic message.

15. The method of claim 1, the method further comprising:
(E) communicating a third electronic message to the task management apparatus from a user account associated with the administrator, the third electronic message including all or a unique portion of the project identifier and instructions for reassigning the first task to a user in the plurality of users other than the non-administrator; and
(F) storing the reassignment, responsive to the third electronic message, the first task to the user.

16. The method of claim 1, the method further comprising:
(E) communicating a third electronic message to the task management apparatus from a user account associated with the administrator, the third electronic message including all or a unique portion of the project identifier and instructions for deleting the first task from the project; and
(F) deleting, responsive to the third electronic message, the first task from the project.

17. A computer comprising:
a central processing unit; and
a memory coupled to the central processing unit, the memory comprising:
(A) a project, the projection comprising:
(i) a project identifier;
(ii) a plurality of tasks, wherein each respective task in the plurality of tasks comprises a task completion status and a task identity; and
(iii) a designation of each user in a plurality of users; wherein the plurality of users comprises an administrator and a non-administrator and wherein each designation of a respective user in the plurality of users comprises an address or identifier of a user account associated with the respective user, wherein
the administrator has a privilege to change the task completion status of each task in the plurality of tasks;
the non-administrator has a privilege to change the task completion status of a subset of the plurality of tasks; and
the non-administrator does not have a privilege to change the task completion status of each task in the plurality of tasks that is not in the subset of tasks; and
(B) a project management module comprising:
(i) instructions for receiving a first electronic message from a user account associated with the administrator, the first electronic message comprising a task identity of each task in the plurality of tasks, wherein the first electronic message optionally includes as a message recipient the address or identifier of the user account associated with the non-administrator,
(ii) instructions for assigning a first task in the subset of tasks to a user in the plurality of users designated by the first electronic message;
(iii) instructions for receiving, at the task management apparatus, a second electronic message from the user account associated with the non-administrator, the second electronic message responsive to the first electronic message or the second electronic message including the identifier for the project, the second electronic message comprising an indication of a completion status of the first task; and
(iv) instructions for updating the completion status of the first task in the electronically stored record of the project without human intervention upon receipt of the second electronic message.

18. The computer of claim 17, wherein
the first electronic message is an E-mail message, Short Message Service (SMS) message, or instant message; and
the user account associated with the administrator is an E-mail account, a SMS account or an instant message screen name.

19. The computer of claim 17, wherein the second electronic message is an E-mail message, a Short Message Service (SMS) message, an instant message, or an Internet communication.

20. The computer of claim 17, wherein a second task in the plurality of tasks comprises one or more subtasks.

21. The computer of claim 20, wherein the second task further comprises a first task completion date and a subtask in the one or more subtasks comprises a subtask completion date that is different than the first task completion date.

22. The computer of claim 20, wherein the one or more subtasks comprise a plurality of subtasks and wherein the project management module further comprises:
(i) instructions for receiving a first set of electronic instructions from the administrator that are operative to assign a first subtask in the plurality of subtasks to a first user in the plurality of users without user intervention; and
(ii) instructions for receiving a second set of electronic instructions from the administrator that are operative to assign a second subtask in the plurality of subtasks to a second user in the plurality of users without user intervention.

23. The computer of claim 22, wherein the first set of electronic instructions and the second set of electronic instructions are in the first electronic message.

24. The computer of claim 22, wherein at least one of (i) the first set of electronic instructions and (ii) the second set of electronic instructions are in an electronic message other than the first electronic message received by the computer from the user account associated with the administrator.

25. The computer of claim 17, wherein the first electronic message is an E-mail message and wherein the designation of each user in the plurality of users in the project is obtained from an electronic distribution list associated with the first electronic message, wherein the electronic distribution list associated with the first electronic message comprises the address or identifier of the user account associated with the non-administrator.

26. The computer of claim 17, wherein a second task in the plurality of tasks comprises a task completion date.

27. The computer of claim 17, wherein the project management module further comprises:
(E) instructions for receiving a third electronic message from a user account associated with a user in the plurality of users, the third electronic message including all or a unique portion of the project identifier and a query for the task completion status of a task in the plurality of tasks of the project; and
(F) instructions for notifying the user account of the user that communicated the third electronic message of the task completion status of the task.

28. The computer of claim 17, wherein the project management module further comprises:
(E) instructions for receiving a third electronic message from a user account associated with a user in the plurality of users, the third electronic message including all or a unique portion of the project identifier and a task reminder for a task in the plurality of tasks of the project; and
(F) instructions for sending a reminder to the user account of the user that communicated the third electronic message at a predetermined time designated by the third electronic message.

29. The computer of claim 17, wherein the first electronic message further comprises a task reminder for a task in the plurality of tasks of the project, and wherein the project management module further comprises:
(v) instructions for sending a reminder to the user account associated with the administrator at a predetermined time designated by the first electronic message.

30. The computer of claim 17, wherein one or more tasks in the plurality of tasks comprises a due date provided by the administrator, and wherein the project management module further comprises:
(v) instructions for receiving a third electronic message from a user account associated with a user in the plurality of users, the third electronic message including all or a unique portion of the project identifier and a request for all due dates for tasks in the plurality of tasks within a date range specified by the third electronic message; and
(vi) instructions for sending, responsive to the third electronic message, all due dates for tasks in the plurality of tasks within a date range specified by the third electronic message.

31. The computer of claim 17, wherein the project management module further comprises:
(v) instructions for receiving a third electronic message from a user account associated with the administrator, the third electronic message including all or a unique portion of the project identifier and instructions for reassigning the first task to a user in the plurality of users other than the non-administrator; and
(vi) instructions for reassigning, responsive to the third electronic message, the first task to the user.

32. The computer of claim 17, wherein the project management module further comprises:
(v) instructions for receiving a third electronic message from a user account associated with the administrator, the third electronic message including all or a unique portion of the project identifier and instructions for deleting the first task from the project; and
(vi) instructions for deleting, responsive to the third electronic message, the first task from the project.

33. A method for defining and managing a plurality of projects on a task management apparatus, wherein each project in the plurality of projects comprises:
a project identifier;
a plurality of tasks, wherein each respective task in the plurality of tasks comprises a task completion status and a task identity; and
a designation of each user in a plurality of users; wherein the plurality of users comprises an administrator and a non-administrator and wherein each designation of a respective user in the plurality of users comprises an address or identifier of a user account associated with the respective user, wherein
the administrator has a privilege to change the task completion status of each task in the plurality of tasks;
the non-administrator has a privilege to change the task completion status of a subset of the plurality of tasks; and
the non-administrator does not have a privilege to change the task completion status of each task in the plurality of tasks that is not in the subset of tasks; and
the method comprises:
(A) communicating a first electronic message to the task management apparatus from a user account associated with the administrator of a project in the plurality of projects, the first electronic message comprising (i) an identity of a project in the plurality of projects, (ii) a task identity of a first task in the plurality of tasks in the project, and (iii) an assignment of the first task to the non-administrator in the plurality of users associated with the project, wherein the first electronic message optionally includes as a message recipient the address or identifier of the user account associated with the non-administrator;
(B) receiving, at the task management apparatus, a second electronic message from the user account associated with the non-administrator, the second electronic message responsive to the first electronic message or the second electronic message including the identifier for the project, the second electronic message comprising an indication of a completion status of the first task; and
(C) updating the completion status of the first task in an electronically stored record of the project on the task management apparatus without human intervention upon receipt of the second electronic message by the task management apparatus.

34. The method of claim 33, wherein
the first electronic message is an E-mail message, Short Message Service (SMS) message, or instant message; and
the user account associated with the administrator is an E-mail account, a SMS account or an instant message screen name.

35. The method of claim 34, wherein the second electronic message is an E-mail message a Short Message Service (SMS) message, an instant message, or an Internet communication.

36. The method of claim 33, wherein a second task in the plurality of tasks of the project comprises one or more subtasks.

37. The method of claim 36, wherein the second task further comprises a task completion date and a subtask in the one or more subtasks comprises a subtask completion date that is different than the task completion date.

38. The method of claim 36, wherein the one or more subtasks comprise a plurality of subtasks and wherein the method further comprises:
(i) receiving a first set of electronic instructions from the administrator that are operative to assign a first subtask in the plurality of subtasks to a first user in the plurality of users without user intervention; and
(ii) receiving a second set of electronic instructions from the administrator that are operative to assign a second subtask in the plurality of subtasks to a second user in the plurality of users without user intervention.

39. The method of claim 38, wherein the first set of electronic instructions and the second set of electronic instructions are in the first electronic message.

40. The method of claim 38, wherein at least one of (i) the first set of electronic instructions and (ii) the second set of electronic instructions are in an electronic message other than the first electronic message received by the task management apparatus from the user account associated with the administrator of the project.

41. The method of claim 33, wherein the first electronic message is an E-mail message and wherein the designation of each user in the plurality of users in the project is obtained by the task management apparatus from an electronic distribution list associated with the first electronic message, wherein the electronic distribution list associated with the first electronic message comprises the address or identifier of the user account associated with the non-administrator.

42. The method of claim 33, wherein a second task in the plurality of tasks of the project comprises a task completion date.

43. The method of claim 33, the method further comprising:
(D) communicating a third electronic message to the task management apparatus from a user account associated with a user in the plurality of users of the project, the third electronic message including all or a unique portion of the project identifier and a query for the task completion status of a task in the plurality of tasks of the project; and
(E) notifying the user account of the user that communicated the third electronic message of the task completion status of the task.

44. The method of claim 33, the method further comprising:
(D) communicating a third electronic message to the task management apparatus from a user account associated with a user in the plurality of users, the third electronic message including all or a unique portion of the project identifier and a task reminder for a task in the plurality of tasks of the project; and
(E) sending a reminder to the user account of the user that communicated the third electronic message at a predetermined time designated by the third electronic message.

45. The method of claim 33, wherein the first electronic message further comprises a task reminder for a task in the plurality of tasks of the project, the method further comprising:
(D) sending a reminder to the user account associated with the administrator at a predetermined time designated by the first electronic message.

46. The method of claim 33, wherein one or more tasks in the plurality of tasks comprises a due date provided by the administrator, the method further comprising:
(D) communicating a third electronic message to the task management apparatus from a user account associated with a user in the plurality of users, the third electronic message including all or a unique portion of the project identifier and a request for all due dates for tasks in the plurality of tasks within a date range specified by the third electronic message; and
(E) sending, responsive to the third electronic message, all due dates for tasks in the plurality of tasks within a date range specified by the third electronic message.

47. The method of claim 33, the method further comprising:
(D) communicating a third electronic message to the task management apparatus from a user account associated with the administrator, the third electronic message including all or a unique portion of the project identifier and instructions for reassigning the first task to a user in the plurality of users other than the non-administrator; and
(E) reassigning, responsive to the third electronic message, the first task to the user.

48. The method of claim 33, the method further comprising:
(D) communicating a third electronic message to the task management apparatus from a user account associated with the administrator, the third electronic message including all or a unique portion of the project identifier and instructions for deleting the first task from the project; and
(E) deleting, responsive to the third electronic message, the first task.

49. A computer comprising:
a central processing unit;
a memory coupled to the central processing unit, the memory comprising:
(A) a plurality of projects, wherein each project in the plurality of projects comprises:
(i) a project identifier;
(ii) a plurality of tasks, wherein each respective task in the plurality of tasks comprises a task completion status and a task identity; and
(iii) a designation of each user in a plurality of users; wherein the plurality of users comprises an administrator and a non-administrator and wherein each designation of a respective user in the plurality of users comprises an address or identifier of a user account associated with the respective user, wherein
the administrator has a privilege to change the task completion status of each task in the plurality of tasks;
the non-administrator has a privilege to change the task completion status of a subset of the plurality of tasks; and
the non-administrator does not have a privilege to change the task completion status of each task in the plurality of tasks that is not in the subset of tasks; and
(A) a project management module comprising:
(i) instructions for receiving a first electronic message from a user account associated with the administrator of a project in the plurality of projects, the first electronic message comprising (i) an identity of a project in the plurality of projects, (ii) a task identity of a first task in the plurality of tasks in the project, and (iii) an assignment of the first task to the non-administrator in the plurality of users associated with the project, wherein the first electronic message optionally includes as a message recipient the address or identifier of the user account associated with the non-administrator; (ii) instructions for receiving a second electronic message from the user account associated with the non-administrator, the second electronic message responsive to the first electronic message or the second electronic message including the identifier for the project, the second electronic message comprising an indication of a completion status of the first task; and
(iii) instructions for updating the completion status of the first task in an electronically stored record of the project without human intervention upon receipt of the second electronic message.

50. The computer of claim 49, wherein
the first electronic message is an E-mail message, Short Message Service (SMS) message, or instant message; and
the user account associated with the administrator is an E-mail account, a SMS account, or an instant message screen name.

51. The computer of claim 50, wherein the second electronic message is an E-mail message, a Short Message Service (SMS) message, an instant message, or an Internet communication.

52. The computer of claim 49, wherein a second task in the plurality of tasks of the project comprises one or more subtasks.

53. The computer of claim 52, wherein the second task further comprises a task completion date and a subtask in the one or more subtasks comprises a subtask completion date that is different than the task completion date.

54. The computer of claim 52, wherein the one or more subtasks comprise a plurality of subtasks and wherein the project management module further comprises:
(i) instructions for receiving a first set of electronic instructions from the administrator that are operative to assign a first subtask in the plurality of subtasks to a first user in the plurality of users without user intervention; and
(ii) instructions for receiving a second set of electronic instructions from the administrator that are operative to assign a second subtask in the plurality of subtasks to a second user in the plurality of users without user intervention.

55. The computer of claim 54, wherein the first set of electronic instructions and the second set of electronic instructions are in the first electronic message.

56. The computer of claim 54, wherein at least one of (i) the first set of electronic instructions and (ii) the second set of electronic instructions are in an electronic message other than the first electronic message received from the user account associated with the administrator of the project.

57. The computer of claim 48, wherein the first electronic message is an E-mail message and wherein the designation of each user in the plurality of users in the project is obtained from an electronic distribution list associated with the first electronic message, wherein the electronic distribution list associated with the first electronic message comprises the address or identifier of the user account associated with the non-administrator of the project.

58. The computer of claim 48, wherein a second task in the plurality of tasks of the project comprises a task completion date.

59. The computer of claim 48, the project management profile further comprising:
(iv) instructions for receiving a third electronic message from a user account associated with a user in the plurality of users, the third electronic message including all or a unique portion of the project identifier of the project and a query for the task completion status of a task in the plurality of tasks of the project; and
(v) instructions for notifying the user account of the user that communicated the third electronic message of the task completion status of the task.

60. The computer of claim 48, the project management profile further comprising:
(iv) instructions for communicating a third electronic message to the task management apparatus from a user account associated with a user in the plurality of users, the third electronic message including all or a unique portion of the project identifier and a task reminder for a task in the plurality of tasks of the project; and
(v) instructions for sending a reminder to the user account of the user that communicated the third electronic message at a predetermined time designated by the third electronic message.

61. The computer of claim 48, wherein the first electronic message further comprises a task reminder for a task in the plurality of tasks of the project, the project management profile further comprising:
(iv) instructions for sending a reminder to the user account associated with the administrator at a predetermined time designated by the first electronic message.

62. The computer of claim 48, wherein one or more tasks in the plurality of tasks comprises a due date provided by the administrator, the project management profile further comprising:
(iv) instructions for communicating a third electronic message to the task management apparatus from a user account associated with a user in the plurality of users, the third electronic message including all or a unique portion of the project identifier and a request for all due dates for tasks in the plurality of tasks within a date range specified by the third electronic message; and
(v) instructions for sending, responsive to the third electronic message, all due dates for tasks in the plurality of tasks within a date range specified by the third electronic message.

63. The computer of claim 48, the project management profile further comprising:
(iv) instructions for receiving a third electronic message from a user account associated with the administrator, the third electronic message including all or a unique portion of the project identifier and instructions for reassigning the first task to a user in the plurality of users other than the non-administrator; and
(v) instructions for reassigning, responsive to the third electronic message, the first task to the user.

64. The computer of claim 48, the project management module further comprising:
(iv) instructions for receiving a third electronic message from a user account associated with the administrator, the third electronic message including all or a unique portion of the project identifier and instructions for deleting the first task from the project; and
(v) instruction for deleting, responsive to the third electronic message, the first task.

65. The method of claim 1, wherein the project further comprises a meeting, the method further comprising assigning a begin date, an end date, and a user to the meeting.

66. The computer of claim 17, wherein the project further comprises a meeting, and wherein the project management module further comprises assigning a begin date, an end date, and a user to the meeting.

67. The method of claim 33, wherein a project in the plurality of projects further comprises a meeting, wherein the method further comprises assigning a begin date, an end date, and a user to the meeting.

68. The computer of claim 49, wherein a project in the plurality of projects further comprises a meeting, wherein the project management module further comprises assigning a begin date, an end date, and a user to the meeting.
